(19) United States
(12) Patent Application Publication
(10) Pub. No.: US 2008/0279115 A1
(43) Pub. Date: Nov. 13, 2008

(54) Method And Device For Implementing Resource Control On An Access Layer For A VC In An L2VPN

(75) Inventor: Jianping Sun, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 12/180,006

(22) Filed: Jul. 25, 2008

Related U.S. Application Data
(63) Continuation of application No. PCT/CN2007/000299, filed on Jan. 26, 2007.

(30) Foreign Application Priority Data
Jan. 26, 2006 (CN) CN200610033417.3

(51) Int. Cl. G01R 31/08; H04L 12/28

(52) U.S. Cl. 370/253; 370/401

(57) ABSTRACT

The present disclosure discloses a method and device for implementing resource control on an access layer for a VC in an L2VPN. In an MPLS network, during the establishment of a VC session, PEs interact with each other through an LDP mapping message from the local end and an LDP mapping message from the remote end for negotiating the bandwidth parameter. The PE device compares the analyzed bandwidth parameter of the opposite end with the bandwidth parameter configured for VC at the local end. If they are consistent, the bandwidth parameter is valid. If they are not consistent, the corresponding bandwidth parameters values are compared, and the bandwidth with the smaller value is valid. Alternatively a negotiation failure message is returned. The present disclosure can realize bandwidth control for each VC on the PE device on the access layer.

### CROSS-REFERENCE TO RELATED APPLICATIONS

This application is a continuation of International Application No. PCT/CN2007/000299, filed Jan. 26, 2007. This application claims the benefit of Chinese Application No. 200610033417.3, filed Jan. 26, 2006. The disclosures of the above applications are incorporated herein by reference.

### FIELD

The present disclosure relates to a Layer 2 Virtual Private Network (L2VPN), and more particular, to a method and device for implementing recourse control on an access layer for a VC in the L2VPN.

### BACKGROUND

The statements in this section merely provide background information related to the present disclosure and may not constitute prior art.

An L2VPN transparently transmits layer 2 data of a user on a Packet Switch Network (PSN), such as a Multi-Protocol Label Switching (MPLS) network. From the view of the user, the PSN is a 2-layer switching network. The 2-layer connection may be established between different sites through the switching network.

In an L2VPN in the Martini mode, a Label Distribution Protocol (LDP) is used by signals that transmit Virtual Circuit (VC) information.

As shown in FIG. 1, a Customer Edge Device (CE) 10 and a CE 11 locate in an L2VPN. A CE 20 and a CE 21 locate in another L2VPN. Taking the Martini mode for example, a Provider Edge Device (PE) A, a PE B, and a Provide Device (P) form an MPLS network. The P is a backbone router locating in the network of an operator. A public Label Switched Path (LSP) is already normally established. An LDP remote session is established between the PE A and the PE B.

Each connection between CEs is allocated with a VC Label by a PE. L2 VPN information carries the VC Label, and forwards the VC Label to the opposite PE of a remote session through the established LSP.

The VC Labels are exchanged through the LDP remote session. The labels adopt a Type-Length-Value (TLV) structure, and are carried in mapping messages. The existing technology adopts an LDP Forwarding Equivalence Class (FEC) to carry the VC information including the VC Label.

At present, with the existing technology, when implementing a Quality of Service (QoS) strategy for an L2VPN on a PE on the access layer, there are two modes. Mode 1 is that traffic speed is controlled on a PE port connected to a CE. Mode 2 is that traffic shaping for a traffic queue is implemented on a PE port connected to a P.

With the existing technology in mode 1, in the case that multiple CEs are connected to the same physical PE interface after a port conversion, it is complex or difficult to perform traffic speed limitation for different CEs on an incoming interface of the PE.

With the existing technology in mode 2, for the VC connection in multiple L2VPNs, in the case that there're fewer interfaces on the network side of the PE, for example, one or two interfaces, it is difficult to differentiate the VCs through different queues. Thus the requirements to guarantee the bandwidth for each VC cannot met.

In other words, if the above cases occur in the network, the existing technology cannot ensure the effective performance of the QoS strategy.

### SUMMARY

An embodiment of the present disclosure provides a method for implementing resource control on an access layer for a VC in an L2VPN. The QoS service is implemented directly on the VC without concerning the port on the access layer or at the network side.

Another embodiment provides a device for implementing resource control on an access layer for a VC in an L2VPN. The resource control is performed for a VC on the access layer in the L2VPN. Thus the QoS service is implemented directly on the VC without concerning the port on the access layer or at the network side.

An embodiment provides a method for implementing resource control on an access layer for a VC in an L2VPN, including:

during an establishment of a VC session, PEs negotiate a bandwidth parameter of the VC through an LDP message. Thus the PE obtains a valid bandwidth parameter; and

the PE controls traffic of the VC according to the valid bandwidth parameter.

Another embodiment provides a device for implementing resource control on an access layer for a VC in an L2VPN, including:

a parameter negotiating module, adapted to negotiate a bandwidth parameter of a VC through an LDP message during an establishment of the VC session, and obtain a valid bandwidth parameter; and

a low-layer forwarding module, adapted to control traffic of the VC according to the valid bandwidth parameter obtained by the parameter negotiating module.

In certain embodiments, during the establishment of a VC session, PEs negotiate a bandwidth parameter of the VC through interacting LDP messages. Therefore, the bandwidth control can be performed on the PEs for each VC on the access layer. The problem is solved that different services cannot be provided in the case that multiple CEs access the identical interface on the PE or multiple VCs use the same out port on the PE. Meanwhile, since the traffic control is realized on the service layer, the manageability can be improved when compared with the existing technology where the traffic control is implemented on the physical layer.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram showing a structure of an L2VPN in the prior art;

FIG. 2 is a schematic diagram showing a negotiation of the bandwidth parameter during an establishment of a VC session in an embodiment;

FIG. 3 is a schematic diagram showing the low-layer forwarding process after the VC statuses are all available in an embodiment of; and

FIG. 4 is a diagram showing a PE diagram in an embodiment.

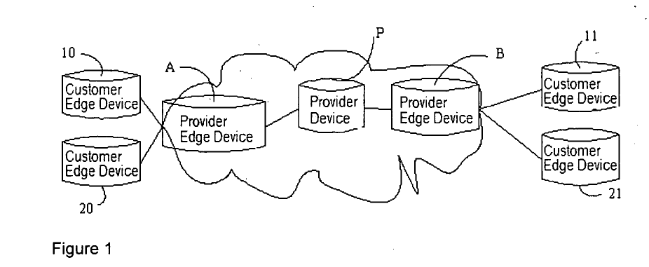

### DETAILED DESCRIPTION

The following description is merely exemplary in nature and is not intended to limit the present disclosure, application, or uses.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The following describes the present disclosure in combination with drawings and embodiments.

In an embodiment, PEs in an MPLS network negotiate a bandwidth parameter when establishing a VC session to implement VC resource control on the access layer.

In an embodiment, an LDP label mapping message may be extended. The Label Mapping message carries a bandwidth parameter to be negotiated.

The LDP label mapping message may includes the contents listed Table 1.

TABLE 1

| | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|
| 0 | 1 | 2 | 3 | 4 | 5 | 6 | 7 | 8 | 9 | 0 1 | 2 | 3 | 4 | 5 | 6 | 7 | 8 | 9 | 0 | 1 | 2 | 3 | 4 5 | 6 | 7 | 8 | 9 | 0 | 1 |

| 0 | Label Message (0x0400) | | Message Length | I |
|---|---|---|---|---|
| Message ID | | | | II |
| 0 | 0 | TLV TYPE (FEC TLV 0x0100) | Length | III |

| | | | | |
|---|---|---|---|---|
| VC TLV (0x080) | 0 | VC Type | Info Length | IV |

| Group ID | | | | V |
|---|---|---|---|---|
| VC ID | | | | VI |
| I/F Parameters | | | | VII |
| 0 | 0 | Generic Label 0x0200 | Length | VIII |

| | |
|---|---|
| Label | IX |
| Optional Parameters | X |

To easily describe the information in Table 1, the contents in Table 1 are divided into ten layers. These layers are described separately.

As shown in Table 1, Lays I and II are LDP message headers, including label message, message length, and message identifier (ID). The label message is the LDP label mapping message (0x0400).

Layer III is the FEC TLV header, including TLV type and TLV length.

Layers IV, V, VI, and V11 are Virtual Circuit FEC Elements, including VC TLV (0x080), VC type, info length, group ID, VC ID, and interface parameters.

Layers VIII, IX, and X are the label TLV headers, including generic label, length, label, and optional parameters.

There is a field of I/F parameters (Interface Parameters) in the VC FEC Elements of the LDP message. At present, the field is used to describe the value of the maximum transmission unit (MTU). The field can be extended to describe a bandwidth parameter configured at the local end for the VC. For example, a bandwidth parameter can be Committed data rate (cdr): 0x00000100, Committed burst size (cbs): 0x00000200, Max burst size (mbs): 0x00000300, and Peak rate (psr): 0x00000400.

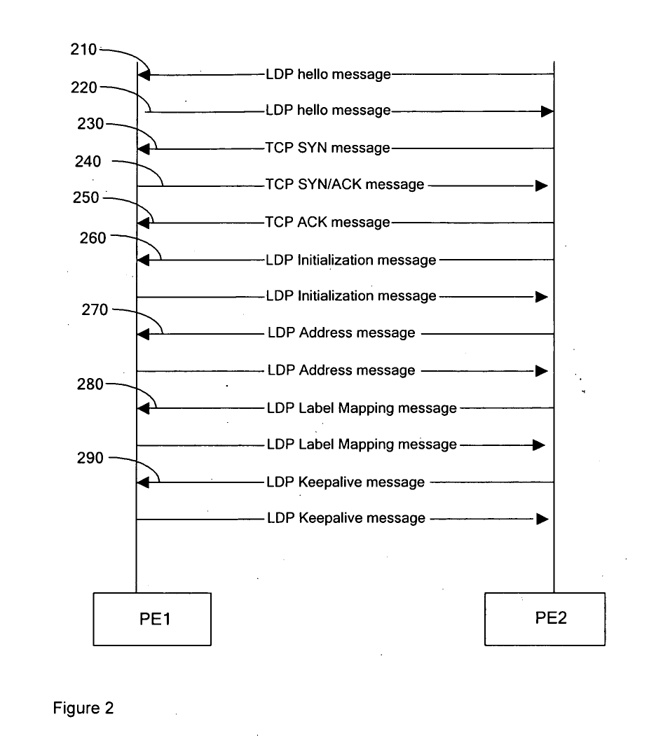

As shown in FIG. 2, in an MPLS network, when establishing a VC session, PEs interact with each other through an LDP label mapping message from the local end and an LDP label mapping message from the opposite end. The PEs negotiate the bandwidth parameter of the two ends. A PE analyses a bandwidth parameter of the opposite end from the field of I/F Parameters in the LDP label mapping message from the opposite end. The PE compares the analyzed bandwidth parameter with a bandwidth parameter configured for the VC at the local end. If the two bandwidth parameters are consistent, the value of the bandwidth parameter is valid. If the two bandwidth parameters are not consistent, the values of the two bandwidth parameter are compared, and the bandwidth with the smaller value is valid, alternatively, if the two bandwidth parameters are not consistent, a negotiation failure message is returned. The bandwidth parameter can be one or more than one. When there is more than one bandwidth parameter, the PEs need to compare the corresponding parameter values respectively of both ends.

For example, PE 2 analyzes the bandwidth parameters transmitted by PE 1 are cdr: 0x00000100, cbs: 0x00000200, mbs: 0x00000300, psr: 0x00000400, and compares these parameters with the bandwidth parameters configured at the local end: cdr: 0x00000100, cbs: 0x00000200, mbs: 0x00000300, psr: 0x00000400. If they are equal, the negotiation succeeds. The values of the bandwidth parameters are valid.

If PE 2 analyzes the bandwidth parameters transmitted by PE 1 are cdr: 0x00000100, cbs: 0x00000200, mbs: 0x00000300 and psr: 0x00000400, and compares these parameters with the bandwidth parameters configured at the local end, such as cdr: 0x00000200, cbs: 0x00000100, mbs: 0x00000300 and psr: 0x00000500. PE 2 may selects the bandwidth parameter cdr: 0x00000100, cbs: 0x00000100, mbs: 0x00000300 and psr: 0x00000400. The negotiation succeeds and the bandwidth parameters take effect. Alternatively, PE 2 returns a negotiation failure message.

In an embodiment, the process of establishing a VC session includes:

1) Neighbor discovery: Neighbor discovery is implemented by transmitting an LDP hello message to each other;

Step 210, the PE 2 transmits an LDP hello message to the PE 1;

Step 220, the PE 1 transmits an LDP hello message to the PE 2.

2) Transmission Control Protocol (TCP) connection establishment: The establishment can be initiated by the party with a larger address;

Step 230, the PE 2 transmits a TCP SYN message to the PE 1;

Step 240, the PE 1 transmits a TCP SYN/ACK message to PE 2;

Step 250, the PE 2 transmits a TCP ACK message to the PE 1.

3) Session initialization and parameter negotiation:

Step 260, the PE 2 and the PE 1 transmit an LDP initialization message to each other to negotiate a parameter;

Step 270, the PE 2 and the PE 1 negotiate the address parameter by transmitting an LDP Address message to each other.

4) Negotiation of Bandwidth Parameters:

Step 280, the PE 2 and the PE 1 interact with each other through an LDP label mapping message from the local end and an LDP label mapping message from the opposite end and negotiate the bandwidth parameters of the two ends.

5) Session Establishment:

Step 290, After the PE 2 and the PE 1 both receive an LDP Keepalive message, the session is established. If any error message is received during the period, the session is closed, and the TCP connection is disconnected.

In an embodiment, the PE processes the traffic control for each VC as follows:

Suppose that the bandwidth of the backbone link and P device are large enough. After the PE is configured with a VC and corresponding bandwidth parameters, it sends the above-mentioned LDP message to negotiate a bandwidth parameter. After the negotiation is completed, the bandwidth parameter obtained from the negotiation acts as a valid parameter for traffic control.

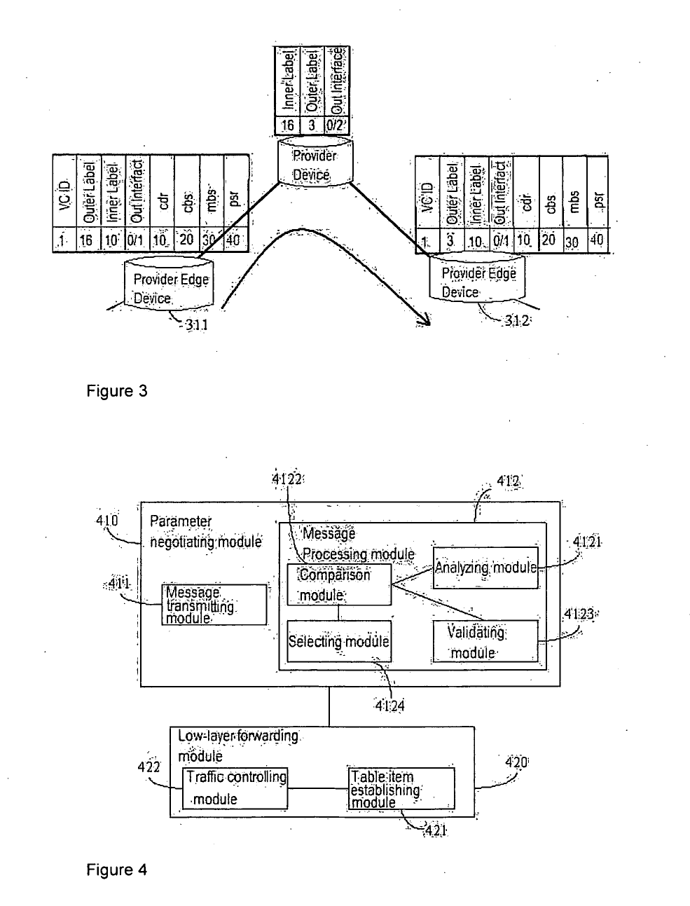

When the status of the VC is available, as shown in FIG. 3, a table item is established on the low-layer forwarding module (not shown in the figure) in PEs 311 and 312. The table item can be combined by two table items.

A table item is in a VC table, as shown in Table 2, at least including VC index (VC ID), outer label, inner label, out interface, and traffic control index (CAR index).

TABLE 2

| | | | | |
|---|---|---|---|---|
| VC ID | Outer Label | Inner Label | Out Interface | CAR Index |

The other is a traffic control table, as shown in Table 3, at least including traffic control index (CAR index), Committed Data Rate (CDR), Committed Burst Size (CBS), Maximum Burst Size (MBS), and Peak Rate (PSR).

TABLE 3

| | | | | |
|---|---|---|---|---|
| CAR Index | CDR | CBS | MBS | PSR |

When performing traffic control, the low-layer forwarding module of the PE controls traffic of a VC by querying the VC table and the traffic control table orderly. The corresponding VC is determined according to information of the message. The corresponding CAR index is searched in the VC table. The traffic control table is searched according to the CAR index. The traffic control is performed according to the parameters in the traffic control table.

The traffic control table acts as a token bucket, continuously injects tokens (X p/s) to the bucket and forwards Y messages. Once the Y message meets the requirement of the VC table, Y tokens are subtracted from the corresponding bucket.

Referring to FIG. 4, a device for implementing resource control on an access layer for a VC in an L2VPN includes a parameter negotiating module 410 and a low-layer forwarding module 420. The parameter negotiating module 410 is adapted to negotiate a bandwidth parameter of a VC through an LDP message during the establishment of the VC session. The parameter negotiating module 410 obtains the valid bandwidth parameter. The low-layer forwarding module 420 is adapted to control traffic of the VC according to the valid bandwidth parameter obtained by the parameter negotiating module 410.

In an embodiment, the parameter negotiating module 410 includes a message transmitting module 411 and a message processing module 412. The message transmitting module 411 is adapted to transmit an LDP label mapping message carrying a bandwidth parameter from a local end. The message processing module 412 is adapted to receive an LDP label mapping message from an opposite end, and perform the negotiation in accordance with a bandwidth parameter carried in an extended field of the LDP label mapping message with the bandwidth parameter configured at the local end.

In the VC FEC elements of the LDP label mapping message, there is a field of I/F parameters. At present, the field is mainly used to describe the interface MTU value. The field can be extended to describe the bandwidth configured for a VC at the local end. The bandwidth parameter includes: CDR, CBS, MBS, and PSR.

The message processing module 412 includes an analyzing module 4121, a comparing module 4122, a validating module 4123, and a selecting module 4124. The analyzing module 4121 is adapted to analyze the bandwidth parameter carried in the LDP label mapping message from the opposite end. The comparing module 4122 is adapted to compare the bandwidth parameter analyzed by the analyzing module with that configured for the VC at the local end. The validating module 4123 is adapted to validate the bandwidth parameter when the comparison result is consistent. The selecting module 4124 is adapted to select the bandwidth parameter with the smaller value when the comparison result is inconsistent.

The low-layer forwarding module 420 includes a table item establishing module 421 and a traffic controlling module 422. The table item establishing module 421 is adapted to establish a VC table and a traffic control table according to the bandwidth parameter negotiated by the parameter negotiating module when the VC status is available. The traffic controlling module 422 is adapted to control traffic of the VC by querying the VC table and the traffic control table.

In addition, in another embodiment, the message processing module 412 includes an analyzing module 4121, a comparing module 4122, a validating module 4123, and a failure message returning module (not shown in the figure). The analyzing module 4121 is adapted to analyze the bandwidth parameter carried in the LDP label mapping message from the opposite end. The comparing module 4122 is adapted to compare the bandwidth parameter analyzed by the analyzing module with that configured for the VC at the local end. The validating module 4123 is adapted to validate the bandwidth parameter when the comparison result is consistent. The failure message returning module is adapted to return a negotiation failure message when the comparison result is inconsistent.

In various embodiments, the device for implementing resource control on an access layer for a VC in an L2VPN can be deployed in the PE.

In various embodiments, during the establishment of a VC session, the bandwidth parameter of the VC is negotiated through the interaction of the LDP messages between PEs. Therefore, the bandwidth control can be implemented on the PEs for each VC on the access layer. The present disclosure solves the problem that difference services cannot be provided in the case that multiple CEs access a PE via the same port or multiple VCs use the same out port on a PE. Meanwhile, since the traffic control is realized on the service layer, the manageability is improved when compared with the existing technology where the traffic control is performed on the physical layer.

What is claimed is:

1. A method for implementing resource control on an access layer for a Virtual Circuit (VC) in a Layer 2 Virtual Private Network (L2VPN) comprising:
negotiating a bandwidth parameter for the VC through a Label Distribution Protocol, (LDP) message between Provider Edges (PEs) during an establishment of a Virtual Circuit (VC) session;
obtaining a valid bandwidth parameter; and
controlling, by a Provider Edge (PE) traffic of the VC according to the valid bandwidth parameter.

2. The method of claim 1, the negotiating the bandwidth parameter for the VC through the LDP message between PEs comprises:
interacting, by the PEs, through an LDP label mapping message from a local end and an LDP label mapping message from an opposite end; and,
performing the negotiation in accordance with a bandwidth parameter carried in an extended field of the LDP label mapping message from the opposite end and a bandwidth parameter configured at the local end.

3. The method of claim 2, wherein the performing the negotiation in accordance with the bandwidth parameter carried in the extended field of the LDP label mapping message from the opposite end and the bandwidth parameter configured at the local end comprises:
comparing, by the PE, the bandwidth parameter carried in the extended field with the bandwidth parameter configured for the VC at the local end; and
if the values of the bandwidth parameters are equal, making the bandwidth parameter valid;
if the values of the bandwidth parameters are not equal, selecting the bandwidth with a smaller value and making the bandwidth with the smaller value valid, or returning a negotiation failure message.

4. The method of claim 2, wherein the extended field carrying the bandwidth parameter in the LDP mapping message is comprised in a field of Interface Parameters in a VC Forwarding Equivalence Class, FEC, element.

5. The method of claim 1, wherein the controlling, by the PE, traffic of the VC according to the valid bandwidth parameter comprises:
establishing a VC table and a traffic control table when the VC status is available.

6. The method of claim 5, wherein the VC table comprises VC index, outer label, inner label, out interface and traffic control index.

7. The method of claim 5, wherein the traffic control table comprises traffic control index and traffic control parameter, and wherein the traffic control parameter is the valid bandwidth parameter.

8. The method of claim 7, wherein the traffic control parameter comprises committed data rate, committed burst size, maximum burst size and/or peak rate.

9. The method of claim 5, wherein a low-layer forwarding module in the PE controls traffic of the VC by querying the VC table and the traffic control table after the low-layer forwarding module establishes the VC table and the traffic control table.

10. A device for implementing resource control on an access layer for a Virtual Circuit (VC) in a Layer 2 Virtual Private Network (L2VPN) comprising:
a parameter negotiating module, adapted to negotiate a bandwidth parameter of a VC through a Label Distribution Protocol (LDP) message and obtain a valid bandwidth parameter during an establishment of a VC session; and
a low-layer forwarding module, adapted to control traffic of the VC according to the valid bandwidth parameter obtained by the parameter negotiating module.

11. The device of claim 10, wherein the parameter negotiating module comprises:
a message processing module, adapted to receive an LDP label mapping message from an opposite end, perform the negotiation in accordance with a bandwidth parameter carried in an extended field of the LDP label mapping message with a bandwidth parameter configured at the local end.

12. The device of claim 11, wherein the parameter negotiating module further comprises: a message transmitting module, adapted to transmit an LDP label mapping message carrying a bandwidth parameter from a local end.

13. The device of claim 12, wherein the message processing module comprises:
an analyzing module, adapted to analyze the bandwidth parameter carried in the LDP label mapping message from the opposite end;
a comparing module, adapted to compare the bandwidth parameter analyzed by the analyzing module with that configured for the VC at the local end;
a validating module, adapted to validate the bandwidth parameter when the values of the bandwidth parameters are equal; and
a selecting module, adapted to select the bandwidth parameter with a smaller value when the values of the bandwidth parameters are not equal.

14. The device of claim 12, the message processing module comprises:
an analyzing module, adapted to analyze the bandwidth parameter carried in the LDP label mapping message from the opposite end;
a comparing module, adapted to compare the bandwidth parameter analyzed by the analyzing module with that configured for the VC at the local end;
a validating module, adapted to validate the bandwidth parameter when the values of the bandwidth parameters are equal; and
a failure message returning module, adapted to return a negotiation failure message when the values of the bandwidth parameters are not equal.

15. The device of claim 12, wherein the low-layer forwarding module comprises:
a table item establishing module, adapted to establish a VC table and a traffic control table according to the valid bandwidth parameter negotiated by the parameter negotiating module; and
a traffic controlling module, adapted to control traffic of the VC by querying the VC table and the traffic control table.

16. The device of claim 13, wherein the low-layer forwarding module comprises:
a table item establishing module, adapted to establish a VC table and a traffic control table according to the valid bandwidth parameter negotiated by the parameter negotiating module; and
a traffic controlling module, adapted to control traffic of the VC by querying the VC table and the traffic control table.

17. The device of claim 14, wherein the low-layer forwarding module comprises:
a table item establishing module, adapted to establish a VC table and a traffic control table according to the valid bandwidth parameter negotiated by the parameter negotiating module; and
a traffic controlling module, adapted to control traffic of the VC by querying the VC table and the traffic control table.
